(19) United States
(12) Patent Application Publication
(10) Pub. No.: US 2008/0177677 A1
(43) Pub. Date: Jul. 24, 2008

(54) Non profit fund raising methodologies with grant of options

(76) Inventor: Toby Unwin, Orlando, FL (US)

Correspondence Address: FURR LAW FIRM, 2622 DEBOLT ROAD, UTICA, OH, 43080, US

(21) Appl. No.: 11/624,986

(22) Filed: Jan. 19, 2007

(51) Int. Cl. G06Q 40/00

(52) U.S. Cl. 705/36 T

(57) ABSTRACT

This invention allows a donor to receive an immediate tax write off from their donation, yet still receive an interest in profits from future research funded by the donation, as a gift of out of the money options. The charity gets a new pool of donors who can potentially make a profit from the donation, making raising funds easier. The company gifting the options receives licensing of intellectual property, grants and loans from the foundation. The system is modeled on German Tax shelter funds.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of non profit fund raising, more particular raising funds through grant options.

2. Background

With the needs of society there is a need for a new method of non profit fund raising.

### PRIOR ART

U.S. Pat. No. 6,542,875 is for charitable and public funding using tax credits and passive losses. It discloses limited partnerships formed for specified public purposes, such as qualified low-income and elderly housing construction and services, are federally tax advantaged. In accordance with this invention, tax credits and/or passive losses are leveraged by being directed into a method of funding charitable works, for instance school construction projects. This is forming limited partnerships to use tax credits to fund charitable projects. The current invention forms no partnerships and uses no tax credits.

U.S. Pat. No. 6,519,573 is for a System and method for charitable giving. This invention is merely a method for accepting donations over the Internet.

U.S. Pat. No. 5,909,794 is for a donation transaction method and apparatus. It allows a user to put coins or notes into a machine and prints a receipt.

U.S. Pat. No. 5,546,303 is for a method of and system for correlating charitable contributions. It issues a drinks coupon in return for a donation

U.S. Pat. No. 6,581,041 is for a method of charitable giving/investing. In an effort to increase charitable giving, it is a method of systematically linking investing with giving by designing a fee structure within an investment whereby a part of the fee is automatically transferred to a donor-advised account within a charitable community foundation. This is merely a system whereby an investment advisor, or credit card company, agrees to donate a portion of their fees to a charity.

None of the current arts covers the current invention. There is still room for improvement in the art.

### SUMMARY OF THE INVENTION

The current invention is a system, method and program product that allows a donor to make a donation to a charity, take an immediate tax write off yet still have the ability to cash in their options and take a big profit when the technology is commercialized. Anything they make from their options is pure profit.

This invention allows a donor to receive an immediate tax write off from their donation, yet still receive an interest in profits from future research funded by the donation, as a gift of out of the money options. The charity gets a new pool of donors who can potentially make a profit from the donation, making raising funds easier. The company gifting the options receives licensing of intellectual property, grants and loans from the foundation. The system is modeled on German Tax shelter funds.

Even “successful” films like Mission Impossible and Lord of the Rings can lose money in theatres, leaving DVD sales and licensing the only way for studios to recoup these losses. How do these films find backing? Most top movies today are financed by German tax shelter funds. It's a good deal for the Germans; they put money into the fund, take an immediate tax write off and still get to keep any profits the fund makes.

The donor receives a tax write off on the money and has nothing to lose.

### BRIEF DESCRIPTION OF THE DRAWINGS

Without restricting the full scope of this invention, the preferred form of this invention is illustrated in the following drawings:

FIG. 1 is a schematic block diagram of a conceptualized operation of the present invention; and

FIG. 2 is a block diagram showing a basic arrangement of a computer system that can run the current invention.

### BRIEF DESCRIPTION OF THE PREFERRED EMBODIMENTS

There are a number of significant design features and improvements incorporated within the invention.

The current invention is a system, method and program product that that allows a donor to make a donation to a charity, take an immediate tax write off yet still have the ability to cash in their options and take a big profit when the technology is commercialized. Anything they make from their options is pure profit. The donor receives a tax write off on the money and has nothing to lose.

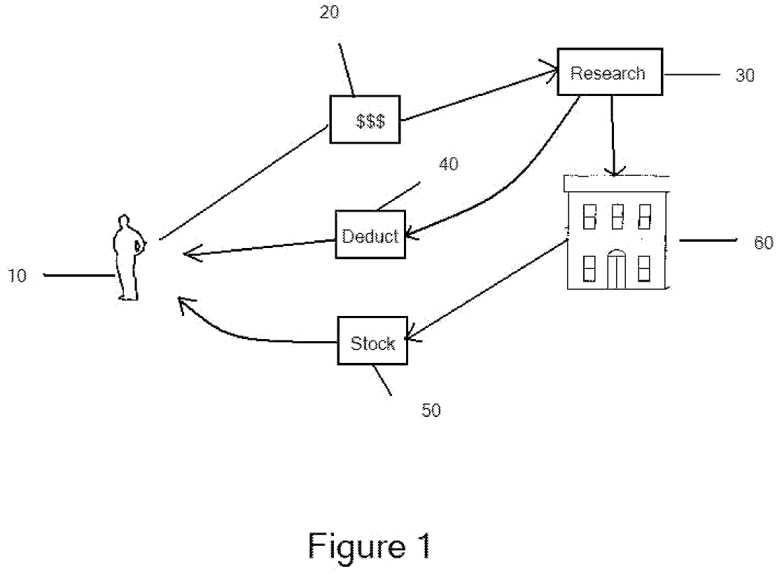

This system is shown in FIG. 1; an example of the system is as follows. An individual 10 donates $10,000 20 to anti-aging research 30. The donor 10 receives a tax ride 40 off on the donated money 20 and gets the right to buy stock 50 at a guaranteed price of whatever the market price currently is when they donate plus 50%. The stock 50 is valued at $1,000. With the 50% “out of the money” the individual receives 15 shares of the company conducting the anti-aging research. Say the company 60 is successful and creates a product which slows aging, the value of shares increases, giving a profit to the donor 10.

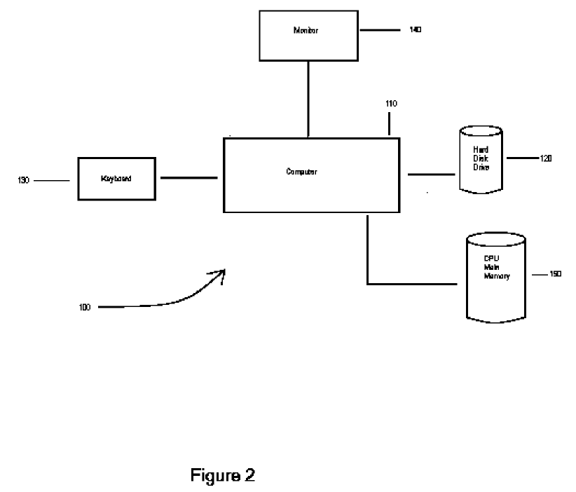

The system 1 can be set up to be run a on a computing device. FIG. 2 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

### Advantages

The advantages of this to donors are; the donations are tax deductible, there is no risk of losing money, and the donors can receive profit from the product.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having a donor make a donation and receiving grant for options.

2. The method as defined in claim 1, wherein said donation is in the form of a donation for research.

3. The method as defined in claim 2, where said donation is to a public company.

4. The method as defined in claim 1, where said option is based on the value of the donation.

6. The method as defined in claim 2, where said donor can receive grant of options out of the money.

7. The method as defined in claim 2, where said donor can buy stock at a guaranteed price.

8. The method as defined in claim 2, where said donation is to a private company.

9. A system comprising: having a donor make a donation and receiving grant for options.

10. A system as defined in claim 9, wherein said donation is in the form of a donation for research.

11. A system as defined in claim 10, where said donation is to a public company.

12. A system as defined in claim 9, where said option is based on the value of the donation.

13. A system as defined in claim 10, where said donor can receive grant of options out of the money.

14. A system as defined in claim 10, where said donor can buy stock at a guaranteed price.

15. A system as defined in claim 10, where said donation is to a private company.

16. A system as defined in claim 10, where said system is run on a computering device.

17. A method comprising the steps: having a donor make a donation and receiving grant for options where said donation is in the form of a donation for research where said option is based on the value of the donation and where said donor can buy stock at a guaranteed price.

18. The method as defined in claim 16, where said donation is to a public company.

19. The method as defined in claim 17, where said donation is to a private company.
